(19) United States
(12) Patent Application Publication
(10) Pub. No.: US 2026/0079041 A1
(43) Pub. Date: Mar. 19, 2026

(54) Weight Scale For Weighing Seated Persons

(71) Applicant: Ebonie Williams, Mokena, IL (US)

(72) Inventor: Ebonie Williams, Mokena, IL (US)

(21) Appl. No.: 18/889,072

(22) Filed: Sep. 18, 2024

(51) Int. Cl. G01G 19/44; G01G 19/52; G01G 23/18

(52) U.S. Cl. CPC G01G 19/44; G01G 19/52; G01G 23/18

(57) ABSTRACT

A weight scale for weighing seated persons includes a first panel, a second panel, a control assembly, and a power supply. The first panel includes a first weight sensor and designed to extend across a buttocks area of a person seated thereon to weigh a first portion of the person. The second panel includes a second weight sensor and designed to extend across soles of feet of a person placed thereon to weigh a second portion of the person. The control assembly is operatively connected to the first panel and the second panel and includes a control unit to show total weight information of the first portion and the second portion received from the first panel and the second panel. The power supply is designed to supply power to the first panel, the second panel, and the control assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to weight scales and more particularly pertains to a new weight scale for weighing seated persons. For different persons, such as the elderly, disabled, or injured, standing may be difficult or impossible. Unfortunately, weight scales are designed to weigh persons only when standing. It is therefore difficult to obtain an accurate weight of such persons without specialized equipment or assistance.

This situation can be especially challenging in the medical field, where often appropriate medication dosage and medical diagnosis and observation require knowledge of the weight of a person. The weight scale of the present application utilizes a two-part system that allows for weighing of persons seated in chairs or wheelchairs by weighing one portion of the person and another portion of the person then totaling the two weights to arrive at a total weight of the person.

### (2) Description of Related Art Including Information Disclosed under 37 CFR 1.97 and 1.98

The prior art relates to weight scales. The prior art, as best understood, does not disclose a weight scale for weighing seated persons that includes, a first panel, a second panel, and a control assembly, wherein the first panel weighs a first portion of the person, the second panel weighs a second portion of the person, and the control assembly shows total weight information of the first portion and the second portion.

### BRIEF SUMMARY OF THE INVENTION

An embodiment of the disclosure meets the needs presented above in a weight scale generally comprising a first panel, a second panel, a control assembly, and a power supply. The first panel includes a first weight sensor and designed to extend across a buttocks area of a person seated thereon to weigh a first portion of the person. The second panel includes a second weight sensor and designed to extend across soles of feet of a person placed thereon to weigh a second portion of the person. The control assembly is operatively connected to the first panel and the second panel and is configured to show total weight information of the first portion and the second portion received from the first panel and the second panel. The power supply is designed to supply power to the first panel, the second panel, and the control assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a weight scale according to an embodiment of the disclosure.

FIG. 2 is a close-up view of a portion of an embodiment of the disclosure.

FIG. 3 is a top view of an embodiment of the disclosure.

FIG. 4 is a cross-sectional view of an embodiment of the disclosure.

FIG. 5 is a perspective view of an embodiment of the disclosure in use.

FIG. 6 is a perspective view of an embodiment of the disclosure in use.

### DETAILED DESCRIPTION OF THE INVENTION

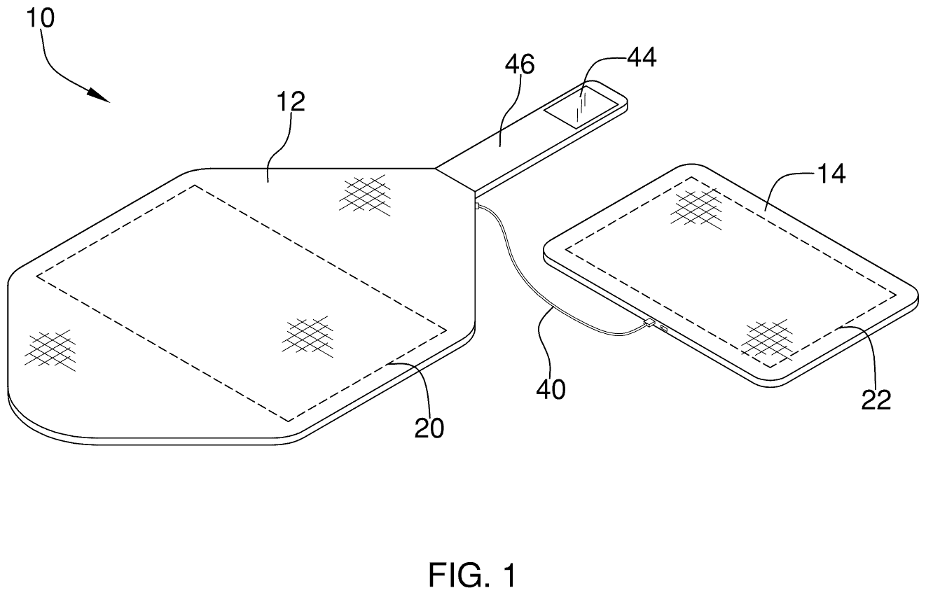

With reference now to the drawings, and in particular to FIGS. 1 through 6 thereof, a new weight scale embodying the principles and concepts of an embodiment of the disclosure and generally designated by the reference numeral 10 will be described.

As best illustrated in FIGS. 1 through 6, the weight scale 10 generally comprises a first panel 12, a second panel 14, a control assembly 16, and a power supply 18. The first panel 12 includes a first weight sensor 20 and designed to extend across a buttocks area of a person 60 seated thereon to weigh a first portion 62 of the person 60. The second panel 14 includes a second weight sensor 22 and designed to extend across soles of feet of a person 60 placed thereon to weigh a second portion 64 of the person 60. The control assembly 16 is operatively connected to the first panel 12 and the second panel 14 and is configured to show total weight information of the first portion 62 and the second portion 64 received from the first panel 12 and the second panel 14. The power supply 18 is designed to supply power to the first panel 12, the second panel 14, and the control assembly 16.

In one possible embodiment, the first panel 12 can be designed to fit different sizes of people. For example, there could be multiple sizes having a width in the range of 12 inches to 30 inches to accommodate children and adults. Similarly, the second panel 14 could be multiple sizes having a width in the range of 8 inches to 20 inches. The first panel 12 could be square or rectangular, or, as shown in the exemplary embodiment, a substantial diamond, hexagonal, or octagonal shape. The second panel 14 could be square or rectangular as well.

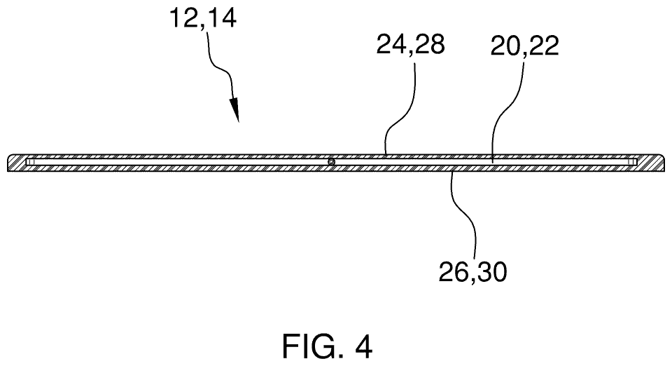

FIG. 4 shows a cross-section of the first panel 12, though for simplicity the cross-sectional view also applies to the second panel 14 and is marked accordingly. The first panel 12 includes a first cover layer 24 and a first reinforcement layer 26 positioned on either side of the first weight sensor 20. In a similar manner and design as the first panel 12, the second panel 14 includes a second cover layer 28 and a second reinforcement layer 30 positioned on either side of the second weight sensor 22. In one possible embodiment, the first reinforcement layer 26 and the second reinforcement layer 30s are relatively rigid or have a rigid portion to provide a firm backing for the first weight sensor 20 and the second weight sensor 22 when they are in the form of a strain gauge load cell common to most digital scales.

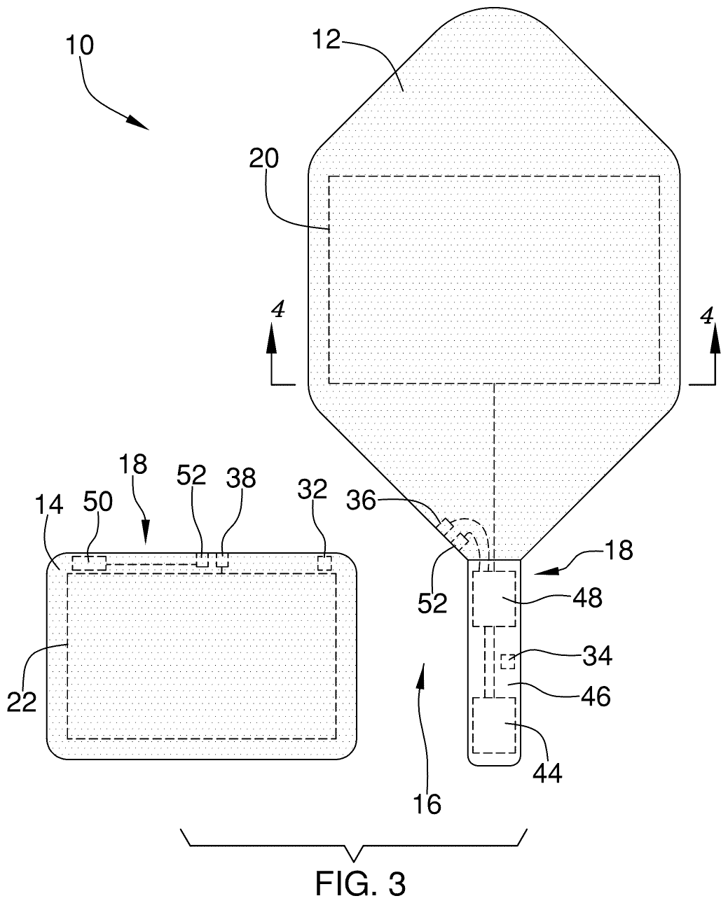

In order to provide communication between the first panel 12 and the second panel 14, as shown in FIG. 3, the control assembly 16 includes a first wireless device 32 in the first panel 12 and a second wireless device 34 in the second panel 14 to permit wireless transfer of information between the first panel 12 and the second panel 14. Such wireless devices could be Bluetooth® or similar wireless technology. Alternatively or in addition to the wireless connection, as shown in FIG. 1, the control assembly 16 includes a first connection port 36 in the first panel 12, a second connection port 38 in the second panel 14, and a wire 40 to permit wired transfer of information between the first panel 12 and the second panel 14. The first connection port 36 and the second connection port 38 could be USB ports and the wire 40 could be a USB cable. The connection, whether wireless or wired, allows for transfer of data between the second panel 14 and the first panel 12 so that the control assembly 16 can add the two separate weight measurements together.

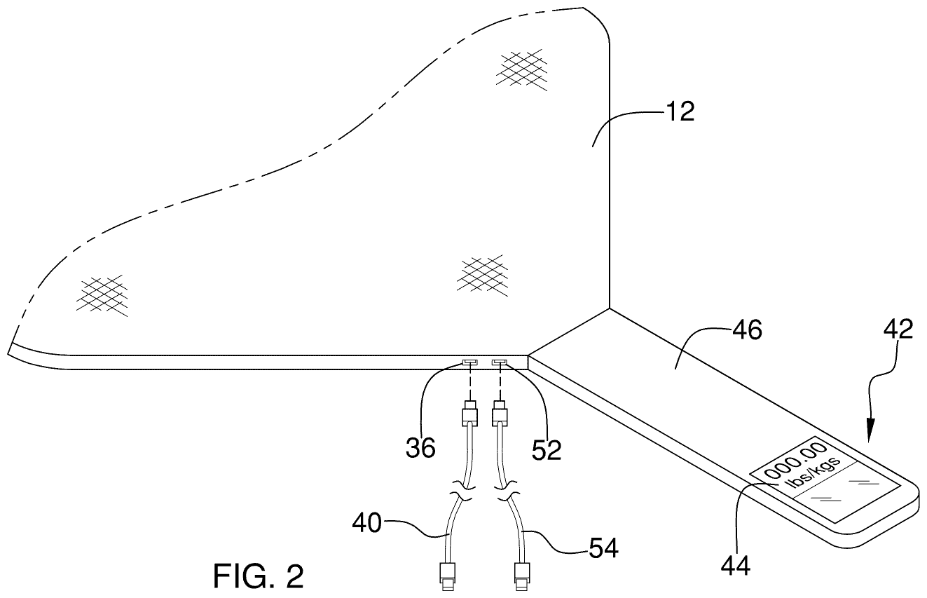

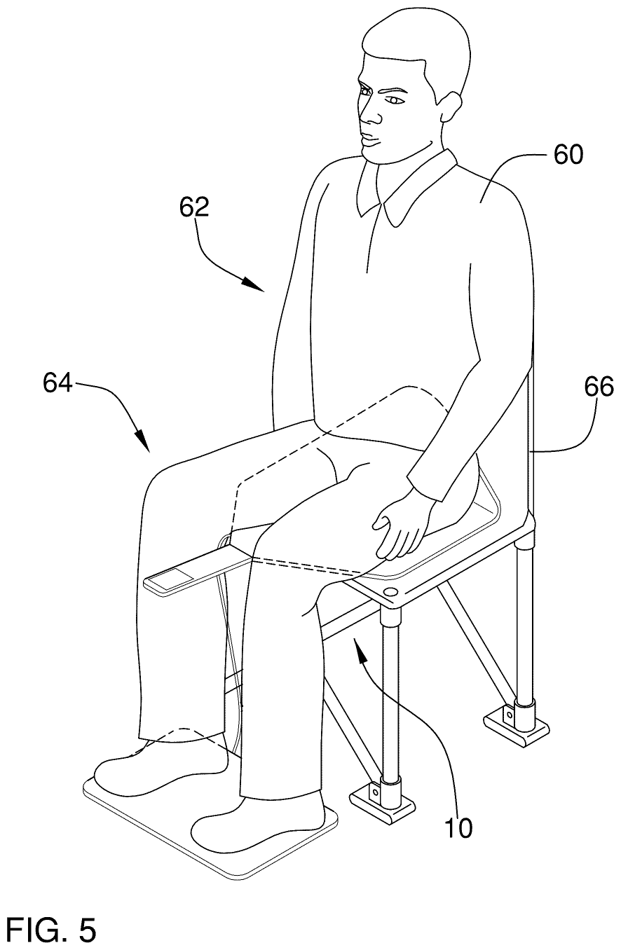

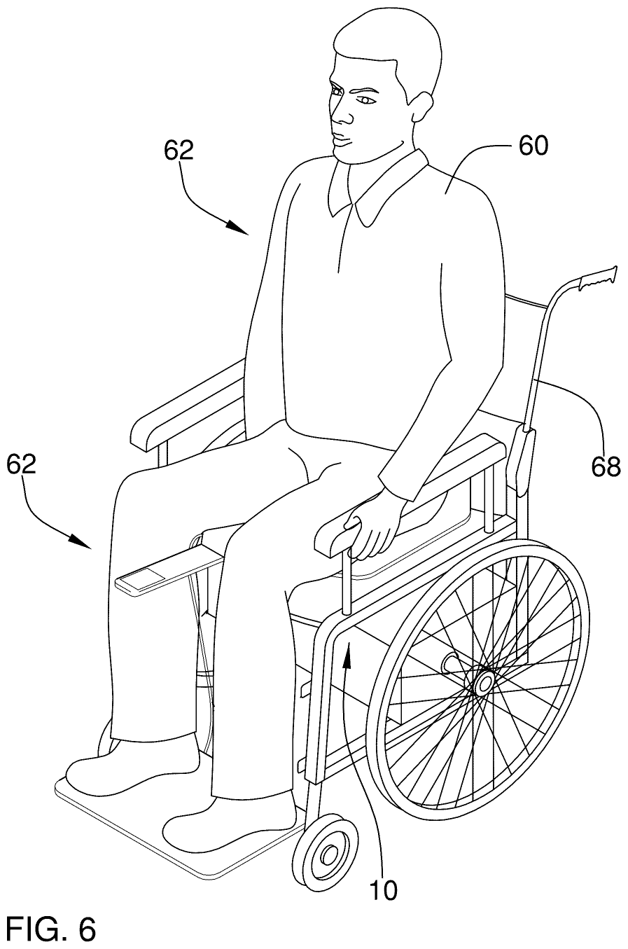

As shown in FIGS. 2 and 3, the control assembly 16 includes a control panel 42 to permit a user to operate the weight scale 10. The control panel 42 includes a display 44 to show information. For example, the display 44 could be in the form of an LCD or digital screen that shows the weight information or other operational information, such as a zeroing out of the weight scale 10. In the exemplary embodiment shown in FIG. 2, the control panel 42 is mounted on a tab 46 projecting from the first panel 12 and between the legs of a person 60 seated on the first panel 12 to permit viewing and operation by the person 60, such as shown in FIGS. 5 and 6.

In the exemplary embodiment shown in FIG. 3, the power supply 18 includes a first rechargeable battery 48 positioned in the first panel 12 and a second rechargeable battery 50 positioned in the second panel 14. Charging ports 52 are located in each of the first panel 12 and the second panel 14 and are connected to the first rechargeable battery 48 and the second rechargeable battery 50. The charging ports 52 could be USB ports into which a USB charging cable 54 could be inserted.

FIGS. 5 and 6 show examples of uses of the weight scale 10. In FIG. 5, a person 60 is seated on a chair 66, and in FIG. 6 a person 60 is seated on a wheelchair 68. The first panel 12 has been placed under the buttocks of the person 60, and the second panel 14 has been placed under the feet of the person 60. When the weight scale 10 is turned on, the weight of the first portion 62 of the person 60, which first portion 62 could include the upper legs, pelvis, torso, head, and arms of the person 60, is weighed by the first panel 12. The weight of the second portion 64 of the person 60, which second portion 64 could include the knees, lower legs, and feet of the person 60, is weighed by the second panel 14. The control assembly 16 adds both of these weights together to arrive at a total weight, which is shown on the display 44 of the control panel 42, which is viewable by the person 60 since the control panel 42 projects out on the tab 46 from the first panel 12 between the legs of the person 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weight scale for weighing seated persons comprising:
a first panel comprising a first weight sensor and configured to extend across a buttocks area of a person seated thereon to weigh a first portion of the person;
a second panel comprising a second weight sensor and configured to extend across soles of feet of a person placed thereon to weigh a second portion of the person;
a control assembly operatively connected to said first panel and said second panel and being configured to show total weight information of the first portion and the second portion received from said first panel and said second panel; and
a power supply configured to supply power to said first panel, said second panel, and said control assembly.

2. The weight scale of claim 1, wherein said first panel comprises a first cover layer and a first reinforcement layer disposed on either side of said first weight sensor, and said second panel comprises a second cover layer and a second reinforcement layer disposed on either side of said second weight sensor.

3. The weight scale of claim 1, wherein said control assembly comprises a first wireless device in said first panel and a second wireless device in said second panel to permit wireless transfer of information between said first panel and said second panel.

4. The weight scale of claim 1, wherein said control assembly comprises a first connection port in said first panel, a second connection port in said second panel, and a wire to permit wired transfer of information between said first panel and said second panel.

5. The weight scale of claim 3, wherein said control assembly comprises a first connection port in said first panel, a second connection port in said second panel, and a wire to permit wired transfer of information between said first panel and said second panel.

6. The weight scale of claim 1, wherein said control assembly comprises a control panel to permit a user to operate the weight scale.

7. The weight scale of claim 6, wherein said control panel comprises a display to show information.

8. The weight scale of claim 7, wherein said control panel is mounted on a tab projecting from said first panel and between the legs of a person seated on said first panel to permit viewing and operation by the person.

9. The weight scale of claim 1, wherein said power supply comprises a first rechargeable battery disposed in said first panel and a second rechargeable battery disposed in said second panel.

10. A weight scale for weighing seated persons comprising:
a first panel comprising a first weight sensor and configured to extend across a buttocks area of a person seated thereon to weigh a first portion of the person, wherein said first panel comprises a first cover layer and a first reinforcement layer disposed on either side of said first weight sensor;
a second panel comprising a second weight sensor and configured to extend across soles of feet of a person placed thereon to weigh a second portion of the person, wherein said second panel comprises a second cover layer and a second reinforcement layer disposed on either side of said second weight sensor;
a control assembly operatively connected to said first panel and said second panel and being configured to show total weight information of the first portion and the second portion received from said first panel and said second panel, wherein:
said control assembly comprises a first wireless device in said first panel and a second wireless device in said second panel to permit wireless transfer of information between said first panel and said second panel,
said control assembly comprises a first connection port in said first panel, a second connection port in said second panel, and a wire to permit wired transfer of information between said first panel and said second panel,
said control assembly comprises a control panel to permit a user to operate the weight scale,
said control panel comprises a display to show information,
said control panel is mounted on a tab projecting from said first panel and between the legs of a person seated on said first panel to permit viewing and operation by the person; and
a power supply configured to supply power to said first panel, said second panel, and said control assembly, wherein said power supply comprises a first rechargeable battery disposed in said first panel and a second rechargeable battery disposed in said second panel.
